(19) United States
(12) Patent Application Publication
(10) Pub. No.: US 2021/0304354 A1
(43) Pub. Date: Sep. 30, 2021

(54) METHOD AND DEVICE FOR ENCODING/DECODING SCALABLE POINT CLOUD

(71) Applicants: Electronics and Telecommunications Research Institute, Daejeon (KR); IUCF-HYU (INDUSTRY-UNIVERSITY COOPERATION FOUNDATION HANYANG UNIVERSITY), Seoul (KR)

(72) Inventors: Eun Young CHANG, Daejeon (KR); Ji Hun CHA, Daejeon (KR); Su Gil CHOI, Daejeon (KR); Euee Seon JANG, Seoul (KR); Li CUI, Seoul (KR); So Myung LEE, Seoul (KR)

(73) Assignees: Electronics and Telecommunications Research Institute, Daejeon (KR); IUCF-HYU (INDUSTRY-UNIVERSITY COOPERATION FOUNDATION HANYANG UNIVERSITY), Seoul (KR)

(21) Appl. No.: 17/259,861

(22) PCT Filed: Jul. 12, 2019
(86) PCT No.: PCT/KR2019/008650

§ 371 Date: Jan. 12, 2021

(30) Foreign Application Priority Data
Jul. 13, 2018 (KR) 10-2018-0081791
Oct. 8, 2018 (KR) 10-2018-0119998
Mar. 21, 2019 (KR) 10-2019-0032400
Apr. 26, 2019 (KR) 10-2019-0049156

(51) Int. Cl. G06T 3/40; G06T 9/00; G06T 5/00

(52) U.S. Cl. CPC G06T 3/40; G06T 2207/20021; G06T 5/002; G06T 9/001

(57) ABSTRACT

There is provided a scalable point cloud encoding/decoding method and apparatus. The scalable point cloud decoding method comprises: acquiring an encoded texture image, an encoded geometry image, encoded occupancy map information, and encoded auxiliary patch-info information from a bitstream; acquiring a decoded texture image for each partition using the encoded texture image; reconstructing a geometry image of at least one item selected from among the encoded geometry image, the encoded occupancy map information, and the encoded auxiliary catch-info information; and reconstructing a point cloud using the texture images for the respective partitions and the geometry image.

### TECHNICAL FIELD

The present invention relates to a scalable encoding/decoding method and apparatus for a point cloud. Specifically, the present invention relates to a partition-based scalable point cloud encoding/decoding method and apparatus.

### Background Art

A conventional encoding/decoding method for an input point cloud does not support the region of spatial scalability (RSS). The conventional encoding/decoding method may mean an anchor software (TMC2) for an MPEG PCC Category 2 dataset. In addition, the conventional encoding/decoding method defines five-level bitrates to support a wide range of quality levels. However, as the bitrate is decreased, a decoded image quality is correspondingly deteriorated. On the other hand, for devices with a small memory capacity or a limited transmission speed, a lower bitrate, i.e., higher compression ratio is desirable. However, in order to provide a better user experience (UX), it is necessary to differently compress between a user interested region and a user non-interested region, for example, with different compression ratios.

In addition, the conventional encoding/decoding method does not support parallel encoding/decoding. The conventional encoding/decoding method includes a patching process and/or an HM encoding process which exhibit a similar processing speed during encoding. At the present, a fast HM encoding chip exists but a fast encoding chip for patching has not yet appeared. Accordingly, it important to design an encoder/decoder capable of performing parallel processing.

### DISCLOSURE

### Technical Problem

Another object of the present invention is to provide an encoding/decoding method and apparatus supporting RSS for a point cloud.

Another object of the present invention is to provide an encoding/decoding method and apparatus supporting RSS for a point cloud.

A further object of the present invention is to provide an encoding/decoding method and apparatus capable of performing parallel processing on a point cloud.

Effects obtained in the present disclosure are not limited to the above-mentioned effects, and other effects not mentioned above may be clearly understood by those skilled in the art from the following description.

### Technical Solution

According to the present invention, there provided a scalable point cloud decoding method comprising: acquiring an encoded texture image, an encoded geometry image, an encoded occupancy map information, and encoded auxiliary patch-info information from a bitstream; acquiring a decoded texture image for each partition using the encoded texture image; reconstructing a geometry image of at least one item selected from among the encoded geometry image, the encoded occupancy map information, and the encoded auxiliary patch-info information; and reconstructing a point cloud using the texture images for the respective partitions and the geometry image.

According to one embodiment, the partition includes at least one item selected from among a slice, a tile, a tile group, and a brick.

According to one embodiment, the reconstructing of the geometry image comprises acquiring a decoded geometry image for each partition using the encoded geometry image.

According to one embodiment, the reconstructing of the geometry image comprises generating decoded occupancy map information for each partition using the encoded occupancy map information.

According to one embodiment, the reconstructing of the geometry image comprises generating decoded auxiliary patch-info information for each partition using the encoded auxiliary patch-info information.

According to one embodiment, the reconstructing of the geometry image comprises smoothing the geometry image.

According to one embodiment, the method further comprises decoding information indicating whether partitioning is applied to the point cloud acquired from the bitstream.

According to one embodiment, the method further comprises decoding at least one type of information among 3D bounding box information and 2D bounding box information on the basis of the information indicating whether the partitioning is applied.

According to one embodiment, at least one type of information among the information indicating the partitioning is applied, the 3D bounding box information, and the 2D bounding box information is signaled via header information.

According to one embodiment, at least one type of information among the information indicating the partitioning is applied, the 3D bounding box information, and the 2D bounding box information is signaled via SEI message information.

According to one embodiment, the method further comprises decoding mapping information indicating a mapping relation among the texture image, the geometry image, the occupancy map information, and the auxiliary patch-info information.

Also, according to the present invention, there is provided a point cloud encoding method comprising: dividing a point cloud into at least one partition; encoding a partition among the partitions using information on the partition; and encoding the information on the partition.

According to one embodiment, the partition includes at least one item selected from among a slice, a tile, a tile group, and a brick.

According to one embodiment, the encoding of the partition comprises generating a geometry image in which each of the partitions are padded with geometry image information.

According to one embodiment, the encoding of the partition comprises generating a texture image in which each of the partitions is padded with texture image information.

According to one embodiment, the encoding of the partition comprises encoding occupancy map information for each of the partitions.

According to one embodiment, the encoding of the partition comprises encoding auxiliary patch-info information for each of the partitions.

According to one embodiment, the information on the partition contains information indicating whether partitioning is applied to the point cloud.

According to one embodiment, the information on the partition contains 3D bounding box information, 2D bounding box information, or both.

According to one embodiment, at least one type of information among the information indicating the partitioning is applied, the 3D bounding box information, and the 2D bounding box information is signaled via header information.

According to one embodiment, at least one type of information among the information indicating the partitioning is applied, the 3D bounding box information, and the 2D bounding box information is signaled via SEI message information.

Also, according to the present invention, there is provided a computer-readable non-transitory recording medium storing image data received, decoded, and used by a scalable point cloud decoding apparatus in a process of reconstructing an image, wherein the image data includes an encoded texture image, an encoded geometry image, encoded occupancy map information, and encoded auxiliary patch-info information, the encoded texture image is used to acquire a decoded texture image for each partition, at least one item selected from among the encoded geometry image, the encoded occupancy map information, and the encoded auxiliary patch-info information is used to reconstruct a geometry image, and the texture image and the geometry image for each partition are used to reconstruct a point cloud.

### Advantageous Effects

According to the present invention, it is possible to provide a partition-based scalable point cloud encoding/decoding method and apparatus.

According to the present invention, it is possible to provide encoding/decoding method and apparatus supporting for a point cloud.

According to the present invention, it is possible to provide an encoding/decoding method and apparatus capable of performing parallel processing on a point cloud.

Effects obtained in the present disclosure are not limited to the above-mentioned effects, and other effects not mentioned above may be clearly understood by those skilled in the art from the following description.

### DESCRIPTION OF DRAWINGS

FIG. 1 is a block diagram illustrating operation of an encoder according to one embodiment of the present invention;

FIG. 2 is a block diagram illustrating operation of a decoder according to one embodiment of the present invention;

FIG. 3 is a diagram illustrating a partition used in a scalable point cloud encoding/decoding method and apparatus according to one embodiment of the present invention;

FIGS. 4 through 8 are diagrams illustrating syntax element information required for implementation of a scalable point cloud encoding/decoding method and apparatus in an encoder/decoder according to one embodiment of the present invention, semantics of the syntax element information, and an encoding/decoding process;

FIGS. 9 through 11 are views illustrating the comparison results between operation of a scalable point cloud encoding/decoding method and apparatus according to one embodiment of the present invention and operation of a conventional encoding/decoding method and apparatus;

FIG. 12 is a block diagram illustrating operation of an encoder according to another embodiment of the present invention;

FIG. 13 is a diagram illustrating information to be encoded according to one embodiment of the present invention;

FIG. 14 is a diagram illustrating operation of a decoder according to anther embodiment of the present invention;

FIGS. 15 and 16 are diagram illustrating the comparison results between operation of a scalable point cloud encoding/decoding method and apparatus according to another embodiment of the present invention and operation of a conventional encoding/decoding method and apparatus;

FIG. 17 is a diagram illustrating a partition used in a scalable point cloud encoding/decoding method and apparatus according to another embodiment of the present invention;

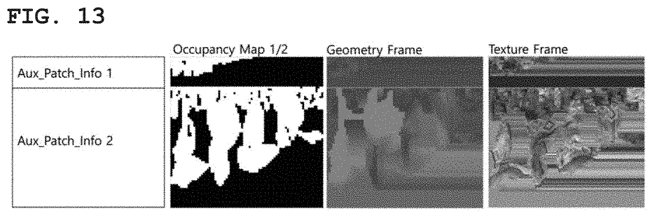

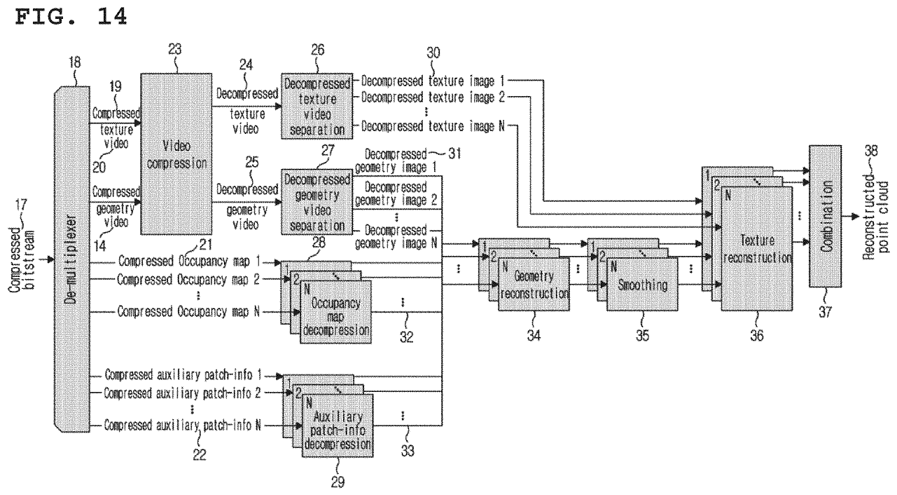

FIGS. 13 through 20 are diagrams illustrating syntax element information required for implementation of a scalable point could encoding/decoding method and apparatus in an encoder/decoder according to another embodiment of the present invention, semantics of the syntax element information, and an encoding/decoding process;

FIG. 21 is a diagram illustrating syntax element information required for implementation of a scalable point could encoding/decoding method and apparatus in an encoder/decoder according to further embodiment of the present invention, semantics of the syntax element information, and an encoding/decoding process;

FIG. 22 is a flowchart illustrating a scalable point cloud decoding method according to one embodiment of the present invention; and

FIG. 23 is a flowchart illustrating a scalable point cloud encoding method according to one embodiment of the present invention.

### BEST MODE

Hereinbelow, exemplary embodiments of the present disclosure will be described in detail such that the ordinarily skilled in the art would easily understand and implement an apparatus and a method provided by the present disclosure in conjunction with the accompanying drawings. In the following explanations and exemplary embodiments of the present disclosure, the substantially identical components are represented by the same reference numerals in order to omit. redundant description. However, the present disclosure may be embodied in various forms and the scope of the present disclosure should not be construed as being limited to the exemplary embodiments.

In describing embodiments of the present disclosure, well-known functions or constructions will not be described in detail when they may obscure the spirit of the present disclosure. Further, parts not related to description of the present disclosure are not shown in the drawings and like reference numerals are given to like components.

In the present disclosure, it will be understood that when an element is referred to as being “connected to”, “coupled to”, or “combined with” another element, it can be directly connected or coupled to or combined with the another element or intervening elements may be present therebetween. It will be further understood that the terms “comprises”, “includes”, “have”, etc. when used in the present disclosure specify the presence of stated features, integers, steps, operations, elements, components, and/or combinations thereof but do not preclude the presence or addition of one or more other features, integers, steps, operations, elements, components, and/or combinations thereof.

It will be understood that, although the terms “first”, “second”, etc. may be used herein to describe various elements, these elements should not be limited by these terms. These terms are only used. to distinguish one element from another element and not used to show order or priority among elements. For instance, first element of one embodiment could be termed a second element of another embodiment without departing from the teachings of the present disclosure. Similarly, the second element of one embodiment could also be termed as the first element of another embodiment.

in the present disclosure, distinguished elements are termed to clearly describe features of various elements and do not mean that the elements are physically separated from each other. That is, a plurality of distinguished elements may be combined into a single hardware unit or a single software unit, and conversely one element may be implemented by a plurality of hardware units or software units. Accordingly, although not specifically stated, an integrated form of various elements or separated forms of one element may fall within the scope of the present disclosure.

In the present disclosure, all of the constituent elements described in various embodiments should not be construed as being essential elements but some of the constituent elements may be optional elements. Accordingly, embodiments configured by respective subsets of constituent elements in a certain embodiment also may fall within the scope of the present disclosure. In addition, embodiments configured by adding one or more elements to various elements also may fall within the scope of the present disclosure.

[symbol]

A conventional encoding decoding method for an input point cloud sequentially performs a patching process and an HM encoding process during encoding/decoding. However, an encoding/decoding method according to the present invention supports region of spatial scalability (RSS). That is, each region of an image can be compressed to have a different image quality. In addition, parallel scalable encoding/decoding for a point cloud is also possible.

Herein below, an encoding/decoding method according to the present disclosure will be described in a manner of comparing with a conventional encoding/decoding method (for example, V-PCC).

[symbol]

The encoding/decoding method and apparatus according to the present disclosure uses the concept of partitions, thereby supporting an RSS function which is one of the requirements for PCC. In addition, since the encoding/decoding method and apparatus according to the present disclosure uses partitions, it is possible to perform parallel encoding/decoding.

In the case of a point cloud model, some regions are may be more interesting regions and other some regions may be relatively uninteresting regions. Thus, the regions may be compressed into different qualities depending on the level of importance of each region. For example, regions which are likely to be of interest to the user have a relatively high bitrate and the remaining regions have a relatively low bitrate.

According to the present invention, input point cloud information is divided into partitions in a three-dimensional space. A bitrate class for encoding is set for each partition. The partition may be at least one of unit selected from among a slice, tile, tile group, or a brick. For each slice or tile, information of one ROI (region of interest) class is generated, and the slices or tiles can be individually encoded. On the other hand, although multiple partitions have the same bitrate, partition-based parallel encoding/decoding can be performed.

[symbol]

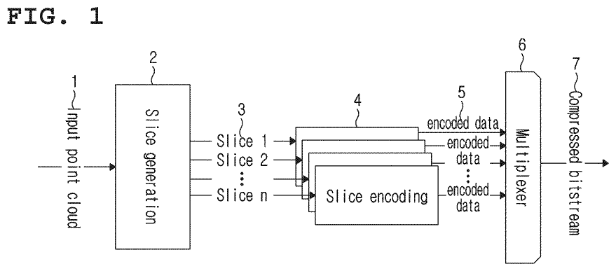

FIG. 1 is a block diagram illustrating operation of an encoder according to one embodiment of the present invention.

In the case of the input point cloud information illustrated in FIG. 1, the partitions refer to slices. However, the present invention is not limited thereto. The partition may be any unit generated from partitioning of point cloud information. For example, it may be a tile, a tile group, or a brick.

Referring to FIG. 1, the encoder can divide an input point cloud 1 into one or more slices (layers) 3 through a slice generation process 2. In addition, the encoder can individually encode the slices 3 using an encoding process 4 (for example, patch generation, image padding, and/or video compression). In addition, the encoder can combine sub-bitstreams 5 corresponding to the respective slices into one bitstream 7 using a multiplexer 6.

[symbol]

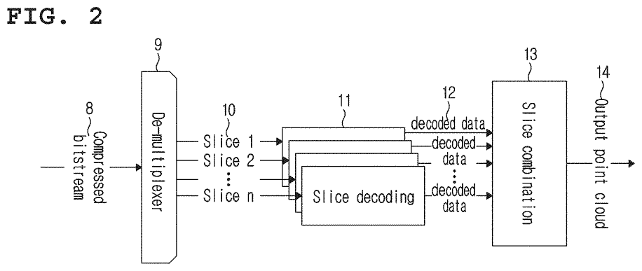

FIG. 2 is a block diagram illustrating operation of a decoder according to one embodiment of the present invention.

In FIG. 2, partitions resulting from division of input point cloud information are slices. However, the present invention is not limited thereto. The partition may be any unit that can be generated by dividing point cloud information. For example, it may be a tile, a tile group, or a brick.

Referring to FIG. 2, the decoder can demultiplex a compressed input bit bitstream 8 into sub-bitstreams 10 corresponding to respective slices using a demultiplexer 9. In addition, the decoder can individually decode the sub-bitstreams 10 using a decoding process 11 (for example patching and or HM decoding). In addition, the decoder can combine data 12 corresponding to each decoded slice into a point cloud 14 using a slice combining process 13.

[symbol]

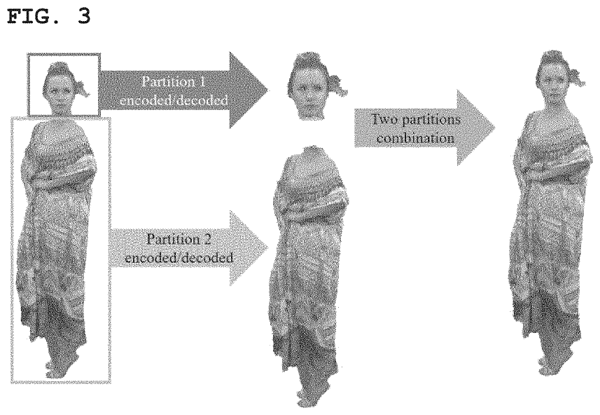

FIG. 3 is a diagram illustrating a partition used in a scalable point cloud encoding/decoding method and apparatus according to one embodiment of the present invention.

Referring to an input point cloud representing one person may be divided into two partitions, i.e., a first partition 1 representing the head and a second partition 2 representing the body. The two partitions can be individually encoded/decoded. The individually decoded partitions may be combined and thus output as a single point cloud. The partition may refer to a slice, a tile, a tile group, or a brick.

[symbol]

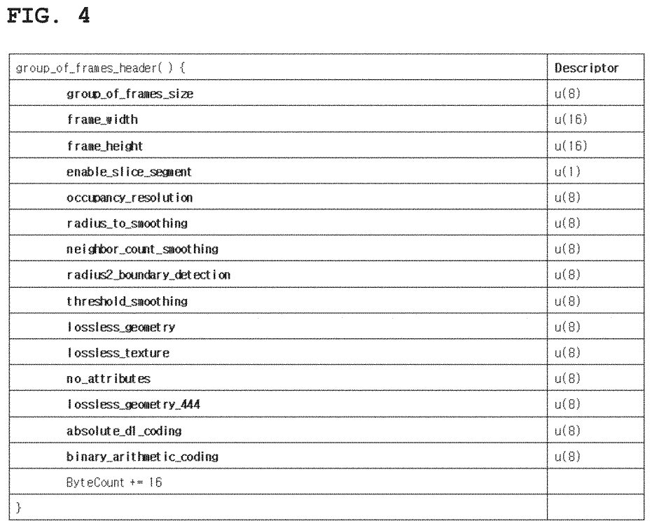

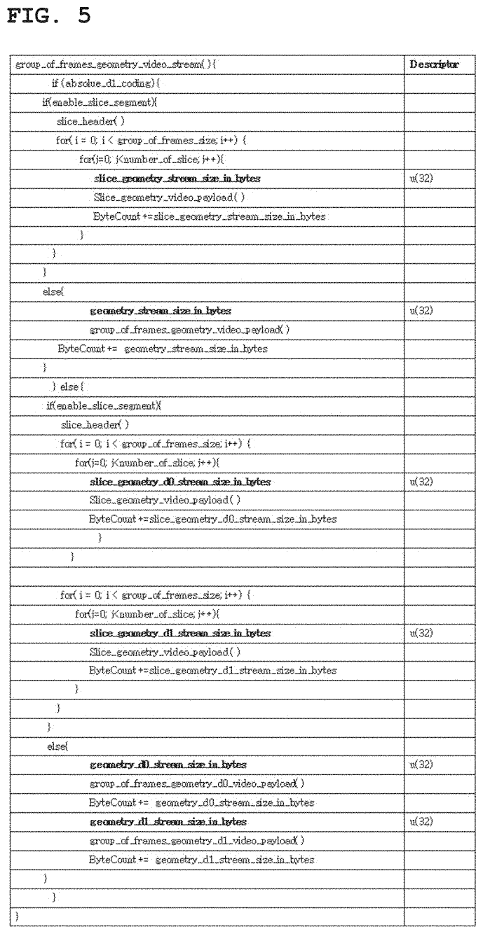

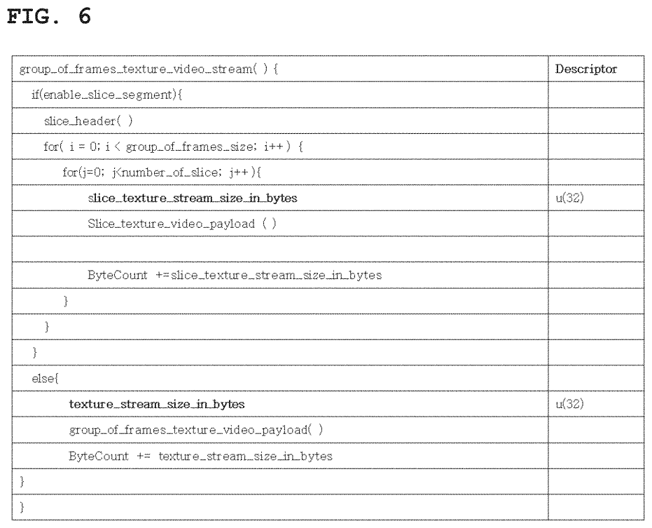

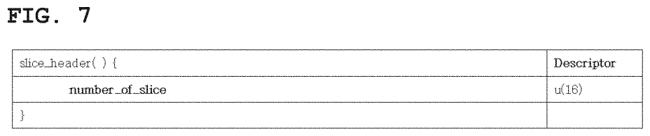

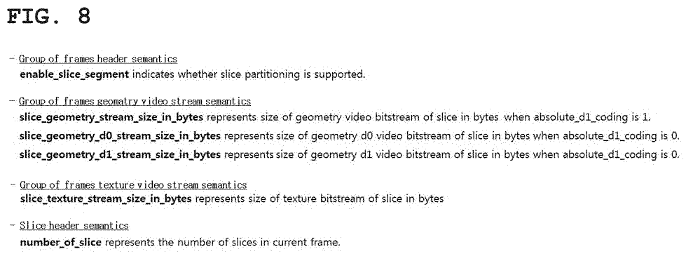

FIGS. 4 through 8 are diagrams illustrating syntax element information required for implementation of a scalable point cloud encoding/decoding method and apparatus in an encoder/decoder according to one embodiment of the present invention, semantics of the syntax element information, and an encoding/decoding process.

Referring to FIGS. 4 to 8, in comparison with a conventional point cloud encoding/decoding process (for example, MPEG FCC Category 2), syntax elements such as enable_slice_segment, slice_geometry_stream_size_in_bytes, slice_geometry_d0_stream_size_in_bytes, slice_geometry_d1_stream_size_in_bytes, slice_texture_stream_size_in_bytes, and number_of_slice are added. The name of each syntax element. may vary depending on embodiments.

[symbol]

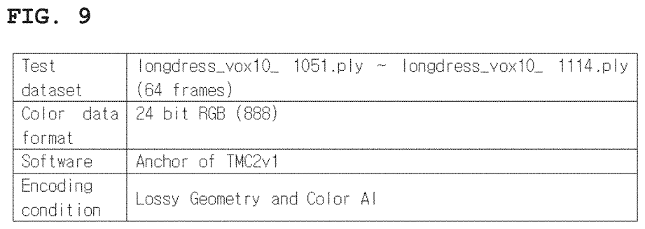

FIGS. 9 through 11 are diagrams illustrating the comparison results between operation of a scalable point cloud encoding/decoding method and apparatus according to one embodiment of the present invention and operation of a conventional encoding/decoding method and apparatus.

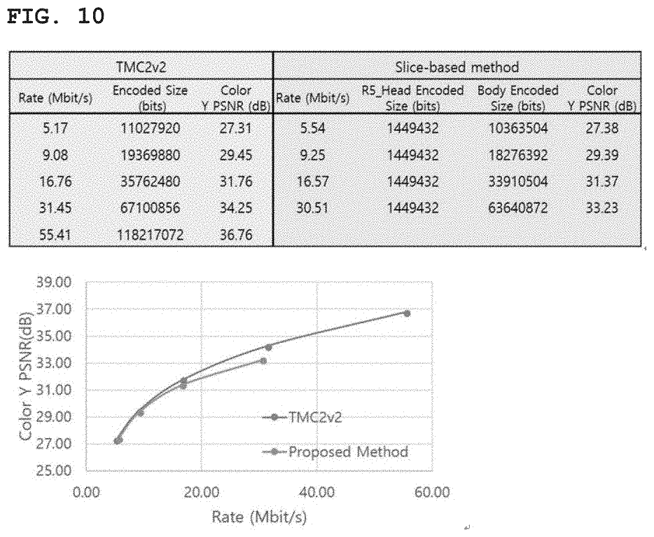

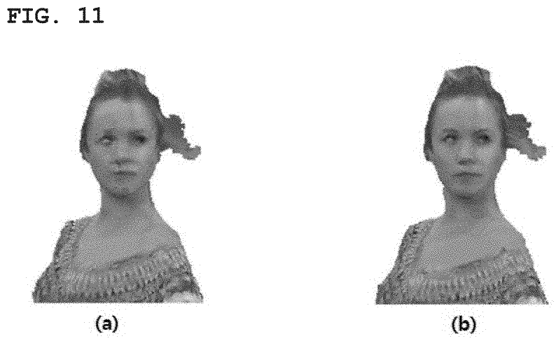

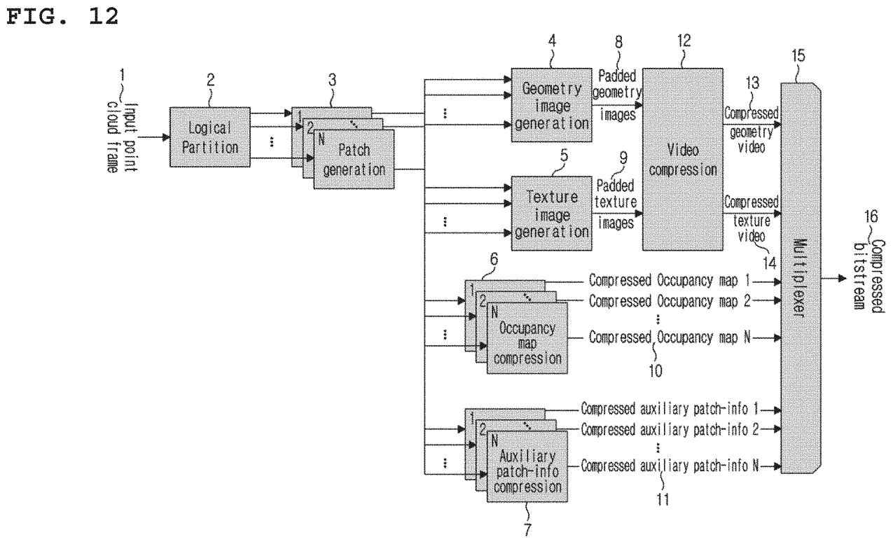

Specifically, FIG. 9 illustrates a test environment, and FIGS. 10 and 11 illustrate comparison results of the performance.

Here, the conventional encoding/decoding method and apparatus may refer to V-PCC. The encoding/decoding method according to the present disclosure is an addition of the components described above with reference to FIGS. 1 through 8 to the V-PCC.

Referring to FIG. 9, in order to compare the two methods, a sequence of Cat 2 (i.e., Longdress_vox10_1051 to 1114.ply) is used as a test dataset. Here, the head part is assumed as a region of interest (ROI). Therefore, a slice (hereinafter, referred to as head slice) corresponding to the head part is encoded with r5 (i.e., a high bitrate) according to Lossy_Geo & Color_AI encoding conditions, and a slice (hereinafter, referred to as a body slice) corresponding to the body part is encoded with r1, r2, r3, and r4 (i.e., low bitrates).

In FIG. 10, V-PCC represents an execution result of a conventional encoding/decoding method and Slice-based method represents an execution results of an encoding/decoding method according to the present disclosure. The execution results of the encoding/decoding method according to the present invention and the conventional encoding/decoding method were similar in terms of PSNR, and an increase in bitrate was nearly few.

Referring to FIG. 11, the image quality of the head part (denoted by reference character (b)) reconstructed by the encoding/decoding method according to the present invention was superior to the image quality of the head part (denoted by reference character (a)) reconstructed by the conventional encoding/decoding method.

[symbol]

FIG. 12 is a block diagram illustrating operation of an encoder according to another embodiment of the present invention.

FIG. 13 is a diagram illustrating information encoded according to another embodiment of the present invention.

In FIGS. 12 and 13, a partition refers to a tile.

Referring to FIG. 12, the encoder divides an input point cloud 1 into multiple partitions using a logical partitioning process 2. The encoder generates path information for each partition using a patch generation process 3. The patch generation process 3 refers to a process used in V-PCC encoding. The patch information may be input to a geometry image generation process 4, a texture image generation process 5, an occupancy map compression process 6, and/or an auxiliary patch-info compression process 7.

The encoder can generate a geometry image 8 in which geometry image information on each partition is padded using the geometry image generation process 4. In FIG. 13, a geometry frame is an example of the geometry image information-padded geometry image 8. The encoder may generate a texture image 9 in which texture image information on each partition is padded using a texture image generation process 5. In FIG. 13, a texture frame is an example of the texture image information-padded texture image. The encoder compresses the geometry image 8 and the texture image 9 using a typical video compression process 12 into compressed geometry video 13 and compressed texture video 14.

The encoder may generate a compressed occupancy map 10 for each partition using an occupancy map compression process 6. In this case, the occupancy map information on each partition is generated in the form of an image like occupancy map ½ of FIG. 13 and compressed through a typical video compression process. Alternatively, run-length encoding is performed on binary bit values acquired in predetermined traversal order and the resulting values are transmitted as information on the respective partitions as illustrated in FIG. 12.

The encoder may generate a compressed auxiliary path-info 11 for each partition using an auxiliary path-info compression process 7.

The encoder combines the compressed geometry video 13, the compressed texture video 14, the compressed occupancy map 10, and/or the compressed auxiliary patch-info 11 into a single compressed bitstream 16 using a multiplexer 15.

[symbol]

FIG. 14 is a diagram illustrating operation of a decoder according to another embodiment of the present invention.

In FIG. 14, a partition means a tile.

Referring to FIG. 14, the decoder demultiplexes a compressed input bitstream 17 into compressed texture video 19, compressed geometry video 20, a compressed occupancy map and/or compressed auxiliary patch-info 22 using a demultiplexer 18.

The decoder may decode the compressed texture video and the compressed geometry video 20 using a video decompression process 23, thereby generating decoded texture video 24 and decoded geometry video 25. In FIG. 13, a texture frame is an example of the decoded texture video 24. In FIG. 13, a geometry frame is an example of the decoded geometry video 25.

The decoder may generate a texture image 30 for each partition from the decoded texture video 24 using a decompressed texture video separation process 26. For example, the decoder may divide the texture frame of FIG. 13 into a first texture image corresponding to a first partition (head part) which is an upper portion of the texture frame and a second texture image corresponding to a second partition 2 (body part) which is a lower portion of the texture frame.

The decoder may generate a geometry image 31 for each partition from the decoded geometry video 25 using a decompressed geometry video separation process 27. For example, the decoder may divide the geometry frame of FIG. 13 into a first geometry image corresponding to the first partition (head part) which is an upper portion of the geometry frame and a second geometry image corresponding to the second partition (body part) which is a lower portion of the geometry frame.

The decoder may generate a decoded occupancy map 32 for each partition from the compressed occupancy map 21 using an occupancy map decompression process 28. The decoder may generate decoded auxiliary patch-info 33 for each partition from the compressed auxiliary patch-info 22 using an auxiliary patch-info decompression process 29.

The decoder may generate reconstructed geometry information by performing a geometry reconstruction process 34 on the decoded geometry images 31 for the respective partitions, the decoded occupancy maps 32 for the respective partitions, and/or the decoded auxiliary patch-info 33 for the respective partitions. In addition, the decoder may generate smoothed geometry information by performing a smoothing process 35 on the reconstructed geometry information.

The decoder may reconstruct point cloud information for each partition by performing a texture reconstruction process 36 on the texture images 30 for the respective partitions and the smoothed geometry information. In addition, the decoder may perform a combination process 37 on the point cloud information for each partition, thereby obtaining a single point cloud 38.

[symbol]

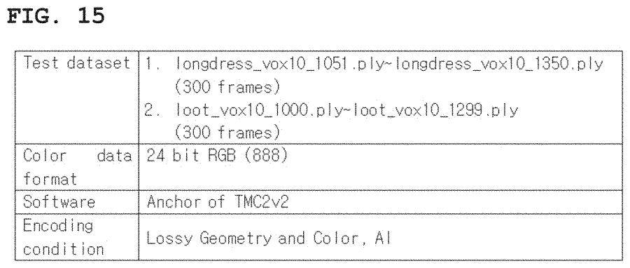

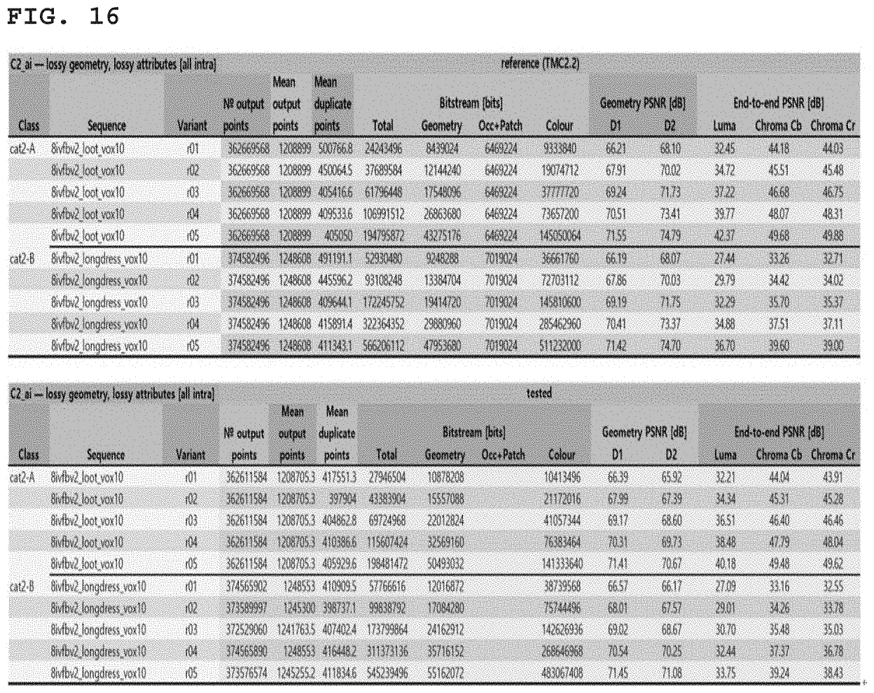

FIGS. 15 and 16 are diagrams illustrating the comparison results between operation of a scalable point cloud encoding/decoding method and apparatus according to another embodiment of the present invention and operation of a conventional encoding/decoding method and apparatus.

Specifically, FIG. 15 illustrates a test environment and FIG. 16 is a diagram illustrating the comparison results of the performance.

Here, the conventional encoding/decoding method and apparatus may refer to V-PCC. The encoding/decoding method according to the present disclosure is an addition of the components described above with reference to FIGS. 12 through 14 to the V-PCC.

As compared with the example shown in FIGS. 9 to 11, the encoding/decoding method according to the present embodiment does not use different bitrates for respective partitions but use the same bitrate for the partitions. Even in this case, it is possible to improve encoding/decoding performance by performing parallel encoding/decoding based or partitions.

[symbol]

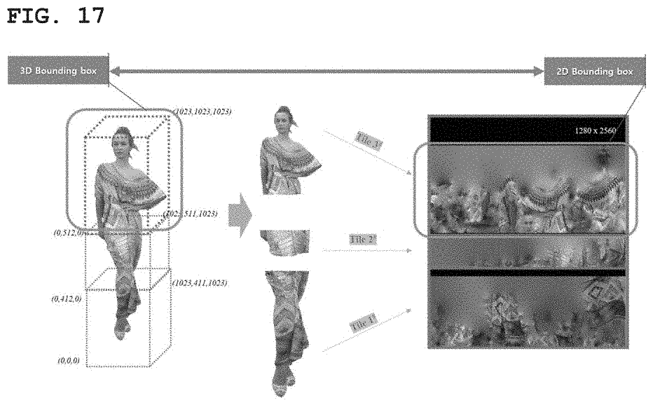

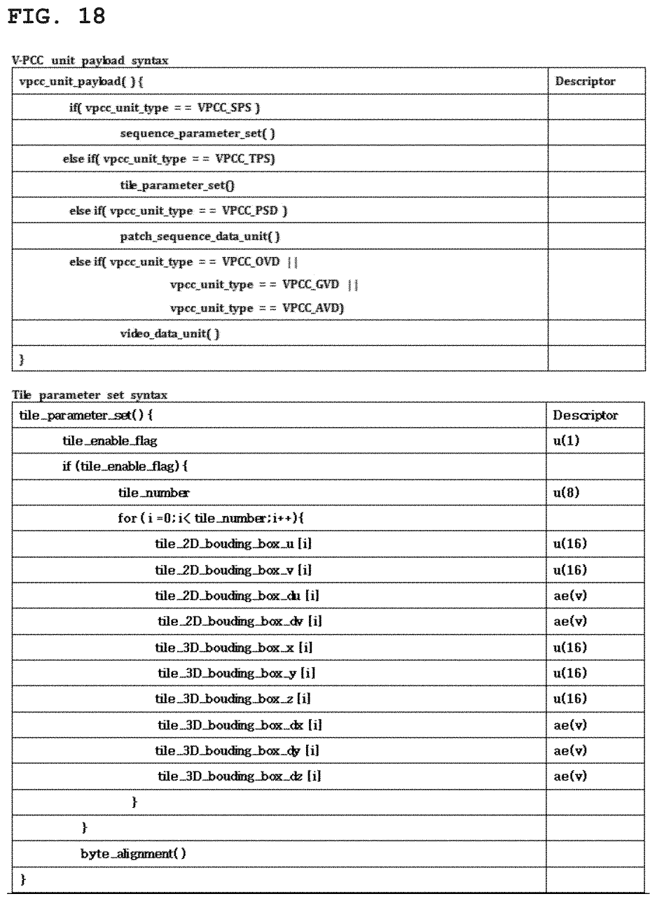

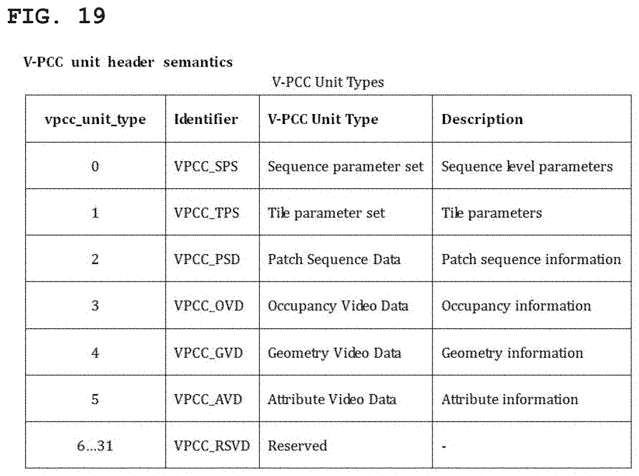

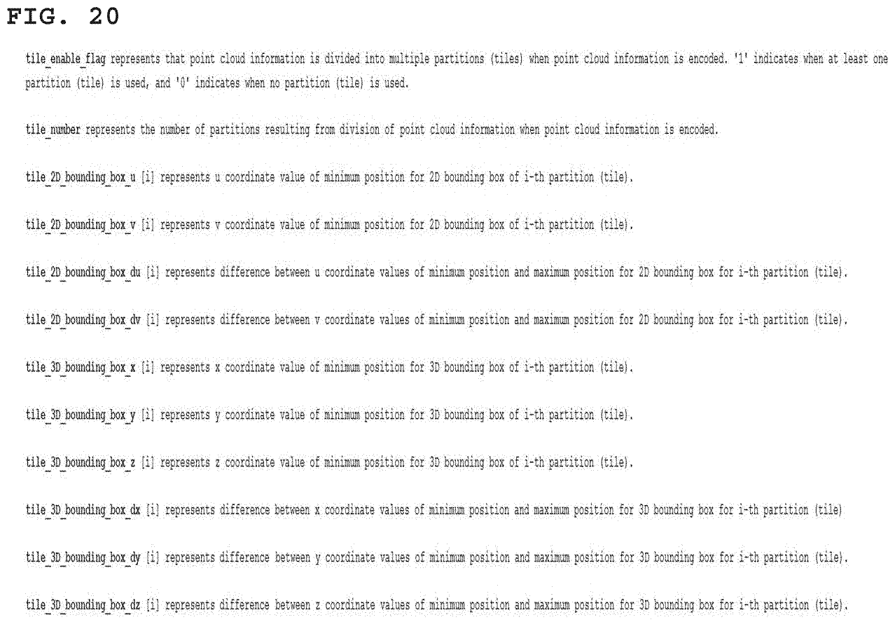

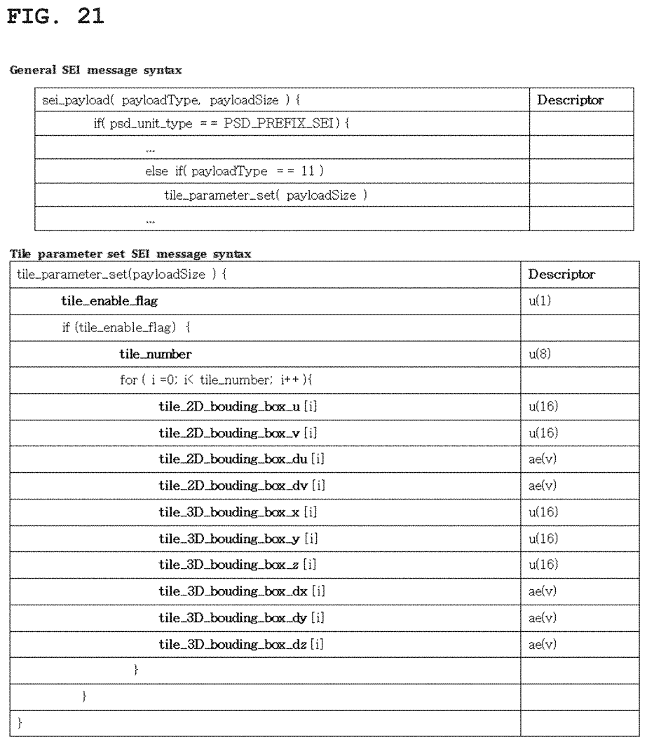

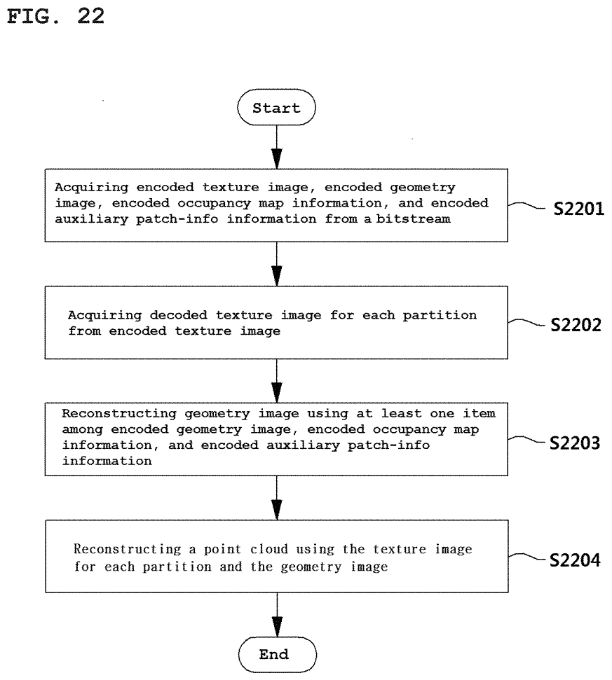

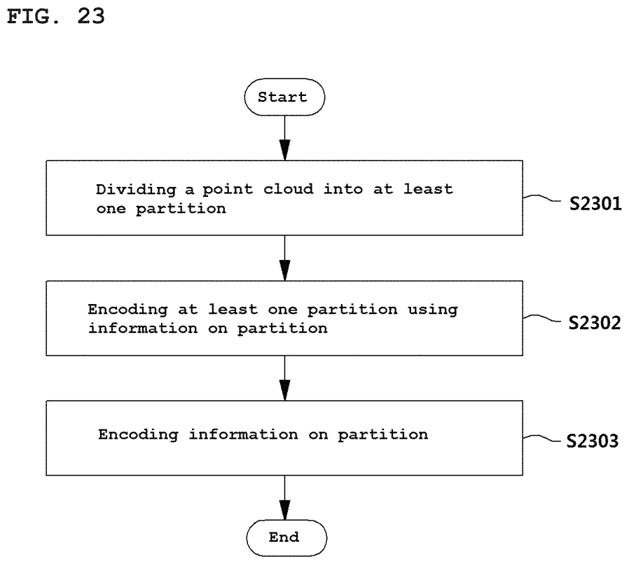

FIG. 17 is a diagram illustrating a partition used in a scalable point cloud encoding/decoding meteor and apparatus according to another embodiment of the present invention.

Referring to 17, an input point cloud representing one person is divided into three partitions using a 3D bounding box. The three partitions may be divided using a 2D bounding box and each partition may be individually encoded/decoded. The individually decoded partitions may be combined and outputted as a single point cloud. In FIG. 17, the partitions may mean tiles but may not be limited thereto. The partition may be a slice, a tile group, or a brick.

[symbol]

In order to implement operation of a scalable point cloud encoding/decoding method and apparatus according to the present invention in an encoder/decoder, predetermined syntax element information may be added to a conventional MPEG V-PCC encoding/decoding process.

For example, information indicating whether a point cloud information is divided into partitions or not may be added. The information may be signaled via header information.

As another example, when a point cloud is divided into multiple partitions, 3D bounding box information for each partition and/or 2D bonding box information for each partition of video data resulting from a patching process may be added. The information may be reconstructed using previously encoded information. However, since such a method increases computational complexity, it is preferable to signal the information via header information.

As further example, mapping information indicating a mapping relation among texture/geometry video, occupancy map information, and auxiliary patch-info information may be added. The mapping information may be signaled via header information.

[symbol]

FIGS. 18 through 20 are diagrams illustrating syntax element information required for implementation of a scalable point cloud encoding/decoding method and apparatus in an encoder/decoder according to another embodiment of the present invention, semantics of the syntax element information, and an encoding/decoding process.

Specifically, FIG. 18 is an embodiment in which predetermined syntax element information is added to a V-PCC unit payload syntax and a tile parameter set syntax used in a conventional MPEG V-PCC encoding/decoding process. FIG. 19 is a diagram illustrating changes in vpcc_unit_type of vpcc_unit_payload( ) in a conventional MPEG V-PCC encoding/decoding when a partition-based encoding/method according to the present disclosure is applied. For example, when the vpcc_unit_type has a value of 1, it can be used as an identifier of VPCC_TPS. FIG. 20 illustrates semantics of added syntax element information shown in FIG. 18.

FIG. 21 is a diagram illustrating syntax element information required for implementation of a scalable point cloud encoding/decoding method and apparatus in an encoder/decoder according to further embodiment of the present invention, semantics of the syntax element information, and an encoding/decoding process.

Referring to FIG. 21, the syntax element information required for implementation of the encoding/decoding method according to the present disclosure is added to a SEI Message syntax. Here, a tile parameter set SEI message may contain parameter information defining a 2D bounding box and/or a 3D bounding box for each partition.

Referring to FIG. 21, payloadType used in sei_paylload( ) may be allocated an identifier indicating additional information required for implementation of the encoding/decoding method according to the present disclosure. FIG. 21 illustrates an example in which the identifier is ‘11’. The tile_parameter_set( ) may contain the same information as the syntax element information that is described above with reference to FIGS. 18 through 20.

[symbol]

FIG. 22 is a flowchart illustrating a scalable point cloud decoding method according to one embodiment of the present invention.

In step S2201, an encoded texture image, an encoded geometry image, encoded occupancy map information, and encoded auxiliary patch-info information are acquired from a bitstream.

In step S2202, a decoded texture image for each partition is acquired from the encoded texture image.

The partition may include any one or more among a slice, a tile, a tile group, and a brick.

In step S2203, a geometry image is reconstructed using one or more items selected from among the encoded geometry image, the encoded occupancy map information, and the encoded auxiliary patch-info information.

The reconstructing of the geometry image includes a step of acquiring a decoded geometry image for each partition from the encoded geometry image. It may include a step of generating decoded occupancy map information for each partition from the encoded occupancy map information. It may include a step of acquiring decoded auxiliary patch-info information for each partition from the encoded auxiliary patch-info information. It may further include a step of smoothing the geometry image.

In step S2204, a point cloud is reconstructed using the texture mage for each partition and the geometry image for each partition.

In addition, information indicating whether partitioning is applied to the point cloud may be acquired by decoding the bitstream.

In addition, 3D bounding box information, 2D bounding box information, or both may be further decoded on the basis of the information indicating whether the partitioning is applied.

On the other hand, at least one type of information among the information indicating whether the partitioning is applied, the 3D bounding box information, and the 2D bounding box information may be signaled via header information.

On the other hand, at least one type of information among the information indicating whether the partitioning is applied, the 3D bounding box information, and the 2D bounding box information may be signaled via SEI message information.

On the other hand, information indicating a mapping relation among the texture image, the geometry image, the occupancy map information, and the auxiliary patch-info information may be decoded.

[symbol]

FIG. 23 is a flowchart illustrating a scalable point cloud encoding method according to one embodiment of the present invention.

In step S2301, a point cloud is partitioned into one or more partitions.

The partition may include at least one unit selected from among a slice, a tile, a tile group, and a brick.

In step S2302, at least one partition may be encoded using information on the partition.

The encoding of the at least one partition may include a step of generating a geometry image in which geometry image information is padded for each partition. It may include a step of generating a texture image in which texture image information is padded for each partition. In addition, it may include a step of encoding occupancy map information for each partition. It may include a step of encoding auxiliary patch-info information for each partition.

In step S2303, the information on each partition may be encoded.

The information on each partition may include information indicating whether partitioning is applied to the point cloud. The information may further include the 3D bounding box information, the 2D bounding box information, or both.

At least one type of information among the information indicating whether partitioning is applied, the 3D bounding box information, and the 2D bounding box information may be signaled via the SEI message information.

[symbol]

As to a computer-readable non-transitory recording medium for storing image data that is received, decoded, and used for image reconstruction by a scalable point cloud decoding apparatus, the image data contains an encoded texture image, an encoded geometry image, encoded occupancy map information, and encoded auxiliary patch-info information. The encoded texture image is used to obtain a decoded texture image for each partition. At least one item among the encoded geometry image, the encoded occupancy map information, and the encoded auxiliary patch-info information is used to reconstruct a geometry image. The texture image for each partition and the geometry image are used to reconstruct a point cloud.

[symbol]

According to the present invention, a partition-based scalable point cloud encoding/decoding method and apparatus is provided.

According to the present invention, an encoding/decoding method and apparatus supporting RSS for a point cloud is provided.

According to the present invention, an encoding/decoding method and apparatus capable of performing parallel processing on a point cloud is provided.

According to the present invention, the use of a partition (tile)-based structure enables parallel encoding/decoding, thereby improving encoding/decoding performance.

The present invention may be applied to an anchor software (for example, TMC3) for a dataset for MPEG PCC Category 2 and/or an anchor software (for example, TMC13) for a dataset for Category 1 and Category 3.

In addition, according to the present invention, a V-PCC structure capable of supporting parallel processing and related syntax/semantics are provided.

In addition, according to the present invention, a V-PCC structure capable of supporting RSS and related syntax/semantics are provided.

In addition, the present invention can be applied to a G-PCC structure by conveying information having the same semantics and the same operational principle.

[symbol]

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments include various aspects of examples. All possible combinations for various aspects may not be described, but those skilled in the art will be able to recognize different combinations. Accordingly, the present invention may include ail replacements, modifications, and changes within the scope of the claims.

The embodiments of the present invention may be implemented in a form of program instructions, which are executable by various computer components, and recorded in a computer-readable recording medium. The computer-readable recording medium may include stand-alone or a combination of program instructions, data files, data structures, etc. The program, instructions recorded in the computer-readable recording medium may be specially designed and constructed for the present invention, or well-known to a person of ordinary skilled in computer software technology field. Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a machine language code formatted by a compiler but also a high level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention can be used to encode/decode a point cloud.

1. A scalable point cloud decoding method comprising:
acquiring an encoded texture image, an encoded geometry image, encoded occupancy map information, and encoded auxiliary patch-info information from a bitstream;
acquiring a decoded texture image for each partition using the encoded texture image;
reconstructing a geometry image of at least one item selected from among the encoded geometry image, the encoded occupancy map information, and the encoded auxiliary patch-info information; and
reconstructing a point cloud using the texture images for the respective partitions and the geometry image.

2. The method according to claim 1, wherein the partition includes at least one item selected from among a slice, a tile, a tile group, and a brick.

3. The method according to claim 1, wherein the reconstructing of the geometry image comprises acquiring a decoded geometry image for each partition using the encoded geometry image.

4. The method according to claim 1, wherein the reconstructing of the geometry image comprises generating decoded occupancy map information for each partition using the encoded occupancy map information.

5. The method according to claim 1, wherein the reconstructing of the geometry image comprises generating decoded auxiliary patch-info information for each partition using the encoded auxiliary patch-info information.

6. The method according to claim 1, wherein the reconstructing of the geometry image comprises smoothing the geometry image.

7. The method according to claim 1, further comprising decoding information indicating whether partitioning is applied to the point cloud acquired from the bitstream.

8. The method according to claim 7, further comprising decoding at least one type of information among 3D bounding box information and 2D bounding box information on the basis of the information indicating whether the partitioning is applied.

9. The method according to claim 8, wherein at least one type of information among the information indicating the partitioning is applied, the 3D bounding box information, and the 2D bounding box information is signaled via header information.

10. The method according to claim 3, wherein at least one type of information among the information indicating the partitioning is applied, the 3D bounding box information, and the 2D bounding box information is signaled via SEI message information.

11. The method according to claim 1, further comprising decoding mapping information indicating a mapping relation among the texture image, the geometry image, the occupancy map information, and the auxiliary patch-info information.

12. A point cloud encoding method comprising:
dividing a point cloud into at least one partition;
encoding at least one partition among the partitions using information on the partition; and
encoding the information on the partition.

13. The method according to claim 12, wherein the partition includes at least one item selected from among a slice, a tile, a tile group, and a brick.

14. The method according to claim 12, wherein the encoding of the partition comprises generating a geometry image in which each of the partitions are padded with geometry image information.

15. The method according to claim 12, wherein the encoding of the partition comprises generating a texture image in which each of the partitions is padded with texture image information.

16. The method according to claim 12, wherein the encoding of the partition comprises encoding occupancy map information for each of the partitions.

17. The method according to claim 12, wherein the encoding of the partition comprises encoding auxiliary patch-info information for each of the partitions.

18. The method according to claim 12, wherein the information on the partition contains information indicating whether partitioning is applied to the point cloud.

19. The method according to claim 18, wherein the information on the partition contains 3D bounding box information, 2D bounding box information, or both.

20. A computer-readable non-transitory recording medium storing image data received, decoded, and used by a scalable point cloud decoding apparatus in a process of reconstructing an image,
wherein the image data includes an encoded texture image, an encoded geometry image, encoded occupancy map information, and encoded auxiliary patch-info information,
the encoded texture image is used to acquire a decoded texture image for each partition,
at least one item selected from among the encoded geometry image, the encoded occupancy map information, and the encoded auxiliary patch-info information is used to reconstruct a geometry image, and
the texture image for each partition and the geometry image are used to reconstruct a point cloud.
